(19) United States
(12) Patent Application Publication
(10) Pub. No.: US 2006/0068839 A1
(43) Pub. Date: Mar. 30, 2006

(54) Using browser-controlled diagnostic channel to manage wireless data terminal devices

(76) Inventors: Henry Kim, San Diego, CA (US); Sidney Park, San Diego, CA (US); James Kim, San Diego, CA (US); Peter You, San Diego, CA (US); Ethan Kim, San Diego, CA (US)

Correspondence Address: FROMMER LAWRENCE & HAUG, 745 FIFTH AVENUE- 10TH FL., NEW YORK, NY, 10151, US

(21) Appl. No.: 11/206,962

(22) Filed: Aug. 18, 2005

Related U.S. Application Data
(60) Provisional application No. 60/602,912, filed on Aug. 18, 2004.

(51) Int. Cl. H04M 1/00

(52) U.S. Cl. 455/552.1; 455/556.1

(57) ABSTRACT

A wireless data terminal apparatus, comprising: a wireless data terminal unit configured to provide data communication over a wireless telecommunication network, the wireless data terminal unit including at least a data processor, an RF section, and a built-in diagnostic unit, wherein the built-in diagnostic unit is configured to process and provide management information of the wireless data terminal unit to enable a browser-based user interface to manage the wireless data terminal unit; and a local area network (LAN) access module coupled to the browser-based user interface and the wireless data terminal unit, the LAN access module including a browser protocol handler to manage user interface functions of the browser-based user interface.

### CROSS-REFERENCE TO RELATED APPLICATIONS

This application claims the benefit of priority of co-pending U.S. Provisional Patent Application Ser. No. 60/602,912 entitled “Data Communication Platform for Wireless Data Terminal”, filed Aug. 18, 2004. Benefit of priority of the filing date of Aug. 18, 2004 is hereby claimed, and the disclosure of the Provisional Patent Application is hereby incorporated by reference.

### BACKGROUND

Wireless telecommunication/data terminal devices (e.g., cellular phones) are finding diversifying applications, such as a data (packet) communication terminal for carrying out electronic mails, chatting and internet browsing, that have evolved from module of speech, a database for the management of classified telephone directory and personal schedule data, as well as a game device and a simple digital camera. The data terminal device is often configured as a plug-in card for a computer to provide an interface to the Internet. The wireless data terminal devices also enable the user to obtain and watch the images and musical contents. Further, in purchasing these contents, payment settlement can be done by using the wireless data terminal device.

Accordingly, the wireless data terminal device is capable of managing a variety of complex data. However, the wireless data terminal device lacks adequate built-in diagnostic tools to provide effective diagnostic tests and updates to fix any problems that may arise.

### SUMMARY

Embodiments of the present invention provide systems, methods, and apparatus for managing, diagnosing, and controlling a wireless data terminal unit.

In one implementation, a wireless data terminal apparatus is disclosed. The apparatus comprises: a wireless data terminal unit configured to provide data communication over a wireless telecommunication network, the wireless data terminal unit including at least a data processor, an RF section, and a built-in diagnostic unit, wherein the built-in diagnostic unit is configured to process and provide management information of the wireless data terminal unit to enable a browser-based user interface to manage the wireless data terminal unit; and a local area network (LAN) access module coupled to the browser-based user interface and the wireless data terminal unit, the LAN access module including a browser protocol handler to manage user interface functions of the browser-based user interface.

In another implementation, a system including a wireless data terminal apparatus is disclosed. The system comprises: a computing device detachably connected to the wireless data terminal apparatus, the computing device including a browser-based user interface; the wireless data terminal apparatus including: a wireless data terminal unit configured to provide data communication over a wireless telecommunication network, the wireless data terminal unit including at least a data processor, an RF section, and a built-in diagnostic unit, wherein the built-in diagnostic unit is configured to process and provide management information of the wireless data terminal unit to enable the browser-based user interface to manage the wireless data terminal unit; and a local area network (LAN) access module coupled to the browser-based user interface and the wireless data terminal unit, the LAN access module including a browser protocol handler to manage user interface functions of the browser-based user interface.

In another implementation, a method is disclosed. The method includes: providing data communication over a wireless telecommunication network using a wireless data terminal unit; processing and providing management information of the wireless data terminal unit using a built-in diagnostic unit in the wireless data terminal unit; coupling a browser-based user interface to the wireless data terminal unit through a LAN access module to manage the wireless data terminal unit; and managing user interface functions of the browser-based user interface using a browser protocol handler.

In another implementation, a browser-based user interface accessible to a user suitable for managing a wireless data terminal unit is disclosed. The user interface includes: means for accessing management configuration in a browser protocol handler; means for accessing management information from a diagnostic module in the wireless data terminal unit; and means for managing the wireless data terminal unit based on the management information configured by the browser protocol handler.

In another implementation, a computer program, stored in a tangible storage medium, for managing, diagnosing, and controlling a wireless data terminal unit is disclosed. The program comprises executable instructions that cause a computer to: provide data communication over a wireless telecommunication network using a wireless data terminal unit; process and provide management information of the wireless data terminal unit using a built-in diagnostic unit in the wireless data terminal unit; couple a browser-based user interface to the wireless data terminal unit through a LAN access module to manage the wireless data terminal unit; and manage user interface functions of the browser-based user interface using a browser protocol handler.

### BRIEF DESCRIPTION OF THE DRAWINGS

FIG. 1 illustrates an integrated wireless data terminal device configured to provide an additional diagnostic channel to a wireless data terminal having an existing data channel.

FIG. 2 shows one example of a user interface screen accessible through the browser.

FIG. 3 shows another example of a user interface screen accessible through the browser.

FIG. 4 illustrates one implementation of a method for entering the management menu of the browser protocol handler (manager).

FIG. 5 illustrates one implementation of a method of changing parameters of the wireless data terminal using the management menu.

FIG. 6 illustrates one implementation of a method of downloading a file to the wireless data terminal using the management menu.

FIG. 7 illustrates one implementation of a method of real-time monitoring of the wireless data terminal using the management menu.

### DETAILED DESCRIPTION

Embodiments of the present invention provide systems, methods, and apparatus for wireless data communication, which integrate the wireless data terminal device with a diagnostic module that manages, diagnoses, and controls the wireless data communication.

The term “wireless data terminal device” as used in this disclosure refers to a telecommunication device that provides data communication over a wireless telecommunication network. In some implementations, the wireless data terminal device is configured as a plug-in card for a personal computer to provide an interface to the Internet. However, in other implementations, the wireless data terminal device is configured as a plug-in device for a cellular phone providing wireless communication over a telecommunication network such as a cellular network.

Thus, in one example, the wireless data terminal device may provide a high-speed Internet access in an area where there is no access to the Internet through a cable line or a public telephone line. In typical implementations, the wireless data terminal device provides only wide-area network communication. In other implementations, the wireless data terminal device provides both wide-area network communication and local-area network communication.

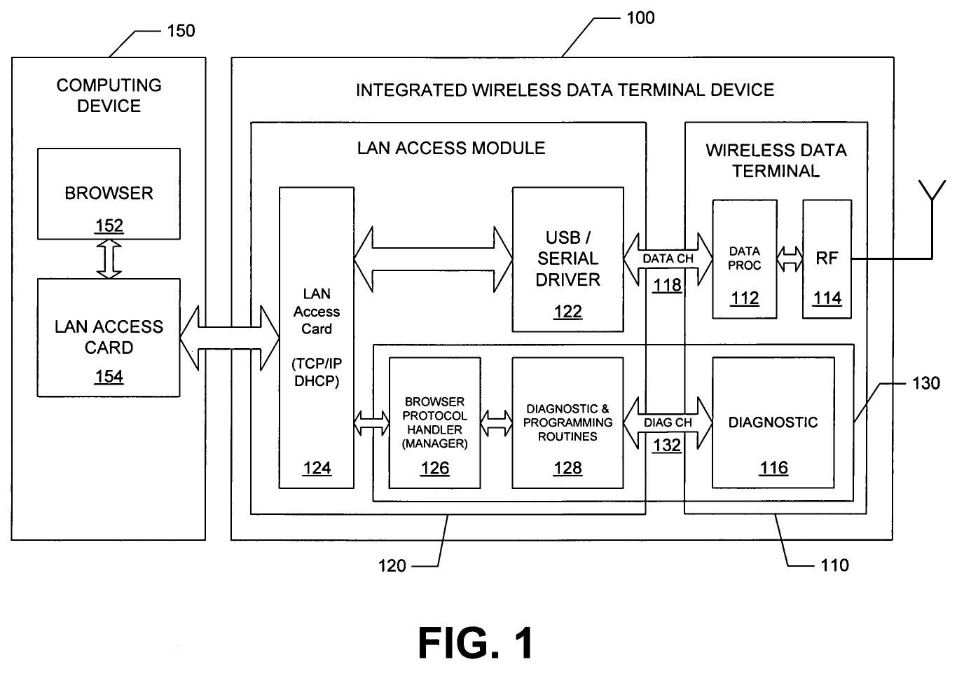

FIG. 1 illustrates an integrated wireless data terminal device 100 configured to provide an additional diagnostic channel 132 to a wireless data terminal 110 having an existing data channel 118. The integrated wireless data terminal device 100 includes the wireless data terminal 110 and a local area network (LAN) access module 120. In one implementation, the LAN access module 120 is an Ethernet module which provides transport protocol for a local area network used in connecting computers, printers, workstations, terminals, and other related devices within close proximity (e.g., within the same building). In accessing the local area network, an Ethernet connection is desirable since the Ethernet connection does not require the installation of any drivers and can support routed networks with ease. Ethernet operates over twisted wire and over coaxial cable at speeds up to 10 Mbps.

The wireless data terminal 110 includes a data processor 112, an RF unit 114, and a diagnostic unit 116. The data processor 112 and the RF unit 114 typically provide functions similar to existing functions provided by a conventional wireless data terminal to enable communication over a wide-area network. The diagnostic unit 116 provides a diagnostic function that enables management, control, and diagnosis of the wireless data terminal 110.

The LAN access module 120 includes a USB/serial bus driver 122, a LAN access card 124, a browser protocol handler unit 126, and a diagnostic/programming routines unit 128. The USB/serial bus driver 122 and the LAN access card 124 provide functions similar to existing functions provided by a conventional LAN access module. The browser protocol handler unit 126 and the diagnostic/programming routines unit 128 provide diagnostic functions to manage, control, and diagnose the wireless data terminal 110.

In the illustrated implementation of FIG. 1, the diagnostic channel 132 provides an interface between units within a diagnostic module 130. The diagnostic module 130 includes the diagnostic unit 116 implemented within the wireless data terminal 110, and the diagnostic/programming routines unit 128 and the browser protocol handler unit 126 implemented within the LAN access module 120. Thus, in one implementation, the diagnostic module 130 provides management and diagnostic tasks such as accessing system status data, accessing security control features, configuring and modifying service parameters, upgrading system software, performing system test, collecting information, downloading and/or debugging system software/firmware, accessing performance status data, and other related tasks. The illustrated configuration of the integrated wireless data terminal device 100 also enables service-oriented diagnostic tasks to be performed without using separate equipment and software tools.

Further, in the illustrated implementation of FIG. 1, the user interface for management, diagnosis, and control of the wireless data terminal 110 is provided by connecting a computing device (e.g., a laptop computer) 150 to the integrated wireless data terminal device 100. The computing device 150 includes a browser 152 and a LAN access card 154. Thus, a user (e.g., a service personnel) can perform all the management, diagnostic, and control tasks using the browser 152 to interface with the diagnostic module 130. In one implementation, the browser 152 is a web browser typically used to process and display web pages. In another implementation, the browser 152 is a menu-driven graphical user interface.

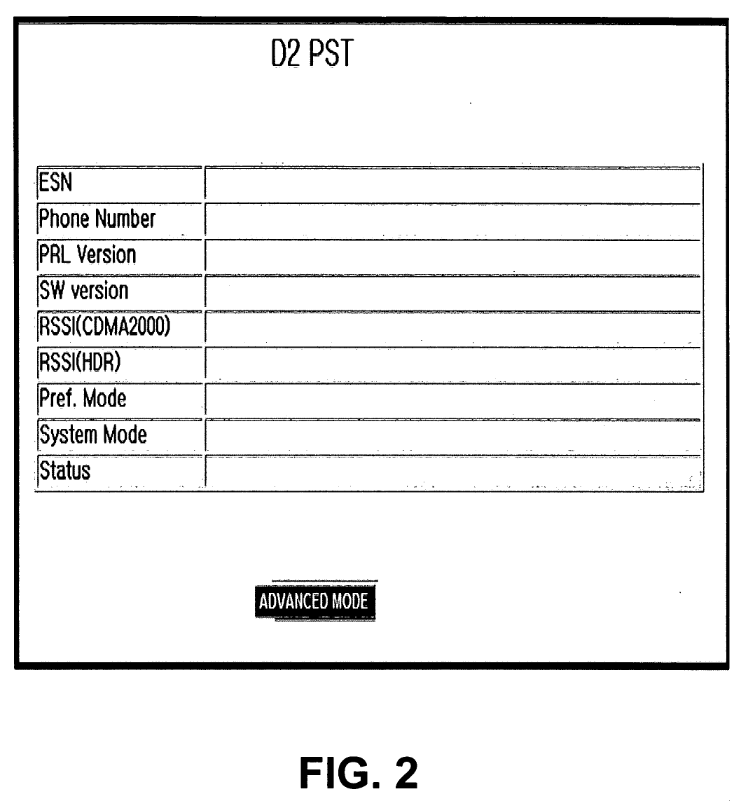

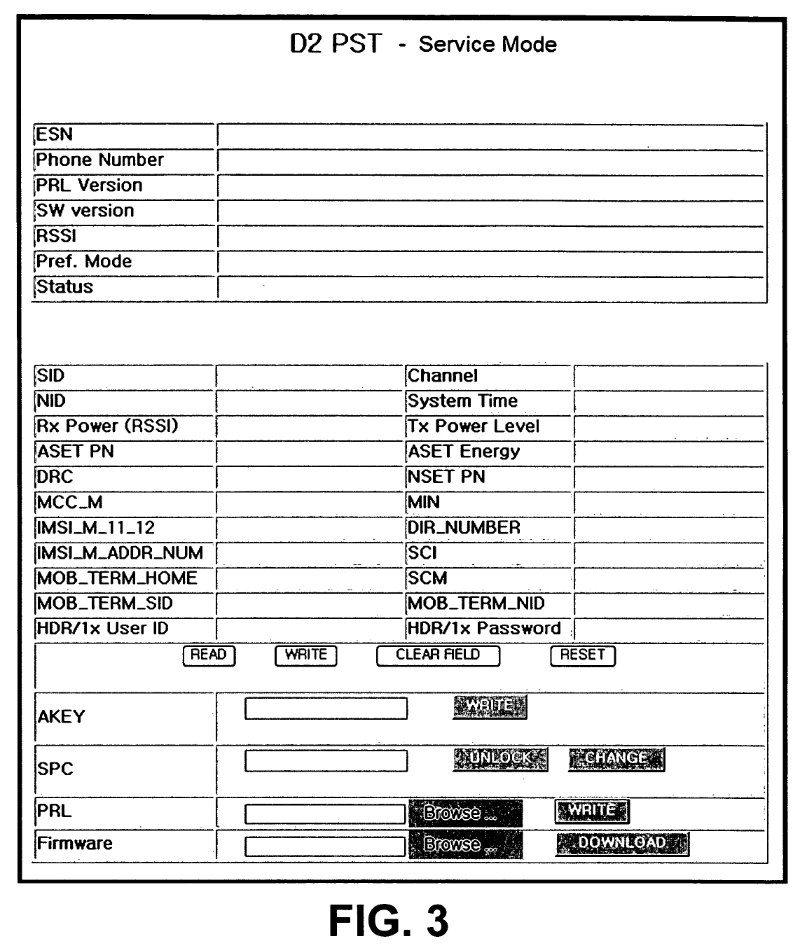

FIG. 2 and FIG. 3 show two examples of user interface screens accessible through the browser 152. FIG. 2 illustrates one example of system information of the wireless data terminal 110. FIG. 3 illustrates one example of accessing performance data.

In one implementation, the connection between the integrated wireless data terminal device 100 and the computing device 150 is configured as a local area network, such as a wi-fi network encompassing any type of 802.11 network (e.g., 802.11a, 802.11b, 802.11g, dual-band, etc.). Further, the local area network can include a wireless access point and a wireless router. The wireless access point is a bridge between a wired and a wireless network. Wireless access points function like a wireless hub connecting all the wireless devices together and then connecting them to a wired network. A wireless network access point facilitates connection to the Internet and/or another network, e.g., an intranet, extranet, WAN, LAN or the like. Many wireless access points are now built into wireless routers so that the features of a broadband router and a wireless access point are provided in one unit.

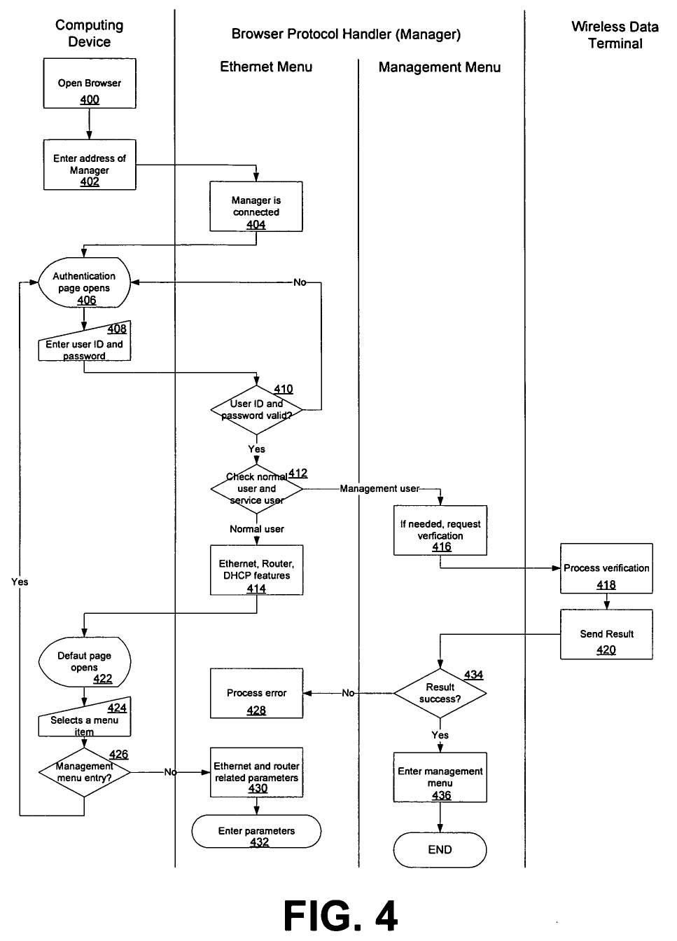

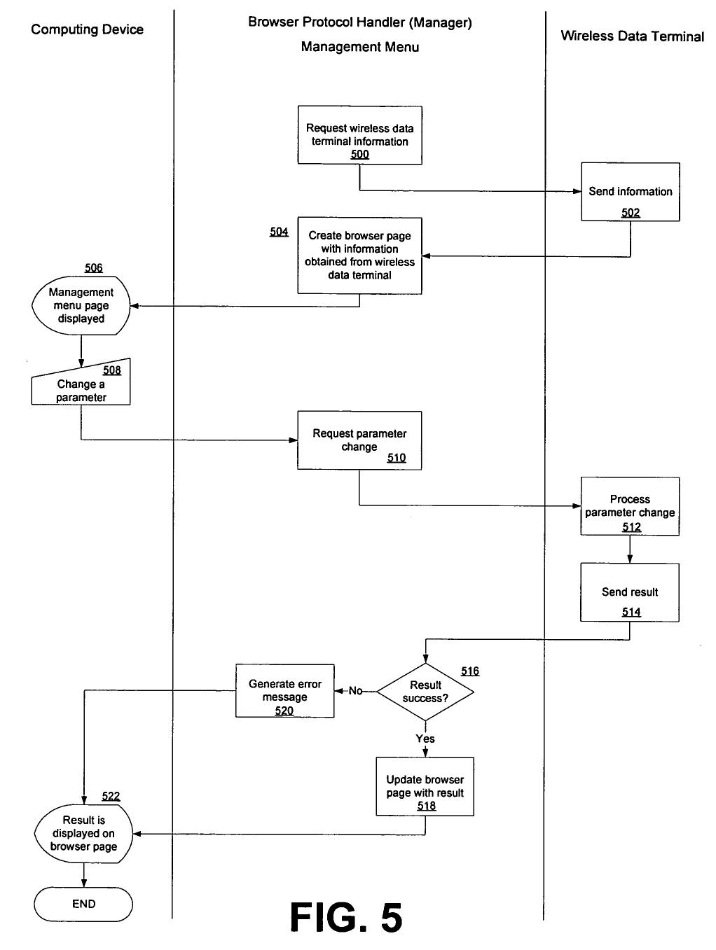

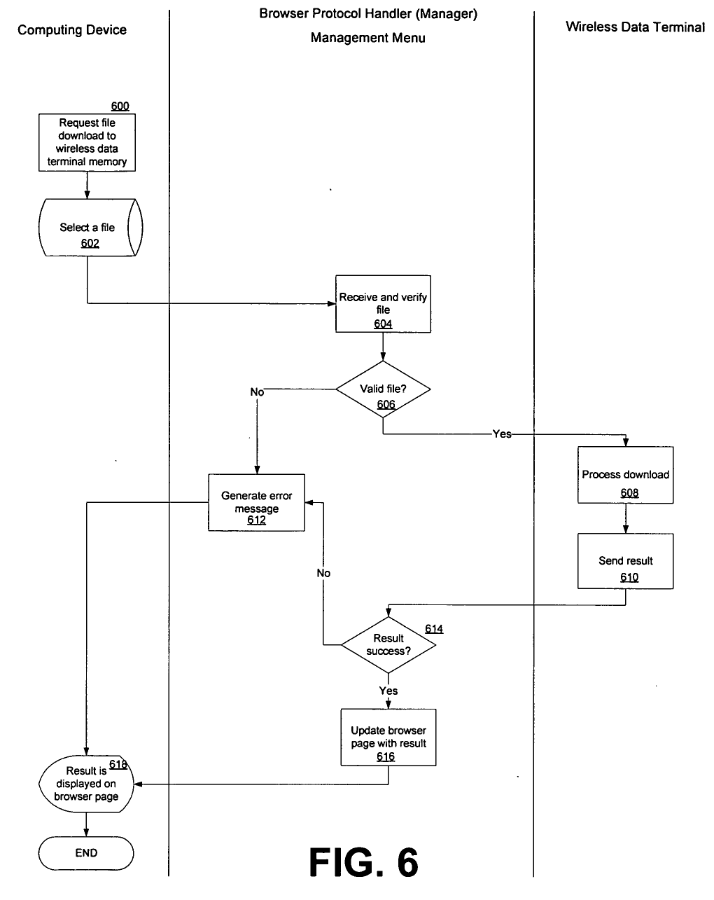

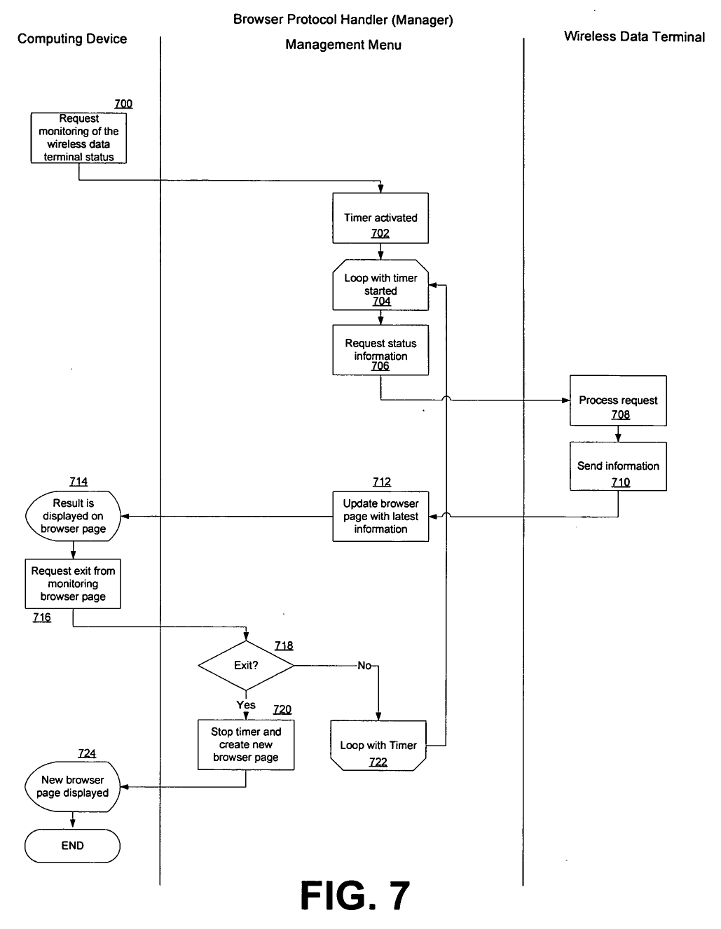

FIG. 4 through FIG. 7 show methods for managing, diagnosing, and controlling the wireless data terminal device in accordance with different task implementations of the present invention. In particular, FIG. 4 illustrates one implementation of a method for entering the management menu of the browser protocol handler (manager) 126; FIG. 5 illustrates one implementation of a method of changing parameters of the wireless data terminal using the management menu; FIG. 6 illustrates one implementation of a method of downloading a file to the wireless data terminal using the management menu; and FIG. 7 illustrates one implementation of a method of real-time monitoring of the wireless data terminal using the management menu.

In the illustrated implementation of FIG. 4, the method for entering the management menu of the browser protocol handler (manager) 126 includes opening the browser at 400, and entering the address of the manager at 402. Then, at 404, the manager is connected, and an authentication page opens, at 406. A request to enter user ID and password is displayed at 408. A validity check is performed, at 410, to determine whether entered user ID and password are valid. If the user ID and password are valid, a user check is performed, at 412. Otherwise, if the user ID and password are not valid, the process returns to authentication page at 406.

If the user is a management user who is authorized to provide management and/or service of the wireless data terminal, user verification is performed by the manager (optional), at 416, and in the wireless data terminal, at 418. The result is then sent to the manager, at 420. If it is determined, at 434, that the verification result at 420 is a success, the user is allowed to enter the management menu, at 436.

Otherwise, if the user is a normal user (i.e., non-management user), Ethernet and router features are activated, at 414, and a default browser page is opened, at 422. The user then selects a menu item, at 424. If a management menu entry is selected, at 426, the process returns to the authentication page at 406. Otherwise, Ethernet and router related parameters are entered and configured, at 430 and 432.

In the illustrated implementation of FIG. 5, the method of changing parameters of the wireless data terminal includes requesting wireless data terminal information, at 500. The wireless data terminal then sends the information, at 502. The manager creates a browser page with information obtained from the wireless data terminal, at 504. A management menu page is displayed, at 506. The user selects parameter change, at 508. The manager requests parameter change, at 510, from the wireless data terminal. The wireless data terminal then processes the parameter change request, at 512, and sends the result to the manager, at 514.

The manager determines, at 516, whether the result returned from the wireless data terminal is a success. If the result is a success, the browser page is updated with the result, at 518. Otherwise, if the result is a failure, the manager generates an error message, at 520, and the result is displayed on the browser page, at 522.

In the illustrated implementation of FIG. 6, the method of downloading a file to the wireless data terminal includes requesting file download to the wireless data terminal memory, at 600, and selecting a file, at 602. The manager receives and verifies the file, at 604.

If the file is determined to be valid, at 606, the wireless data terminal processes the file download, at 608, and sends the result to the manager, at 610. The manager then determines, at 614, if the result was a success. If it was, then the browser page is updated and displayed with the result, at 616 and 618. If the file is determined to be not valid, at 606, or if the result is determined to be a failure, at 614, an error message is generated, at 612, and the result is displayed on the browser page, at 618.

In the illustrated implementation of FIG. 7, the method of real-time monitoring of the wireless data terminal includes requesting monitoring of the wireless data terminal status, at 700. The manager then activates a timer, at 702, loops with the timer started, at 704, and requests status information from the wireless data terminal, at 706. The wireless data terminal processes the request, at 708, and sends the information to the manager, at 710. The manager updates and displays the browser page with latest information, at 712 and 714.

When the user requests exit from real-time monitoring, at 716, the manager determines, at 718, if the exit request was actually made. If it is determined that the exit request was made by the user, the manager stops the timer and generates a new browser page, at 720, and displays the page, at 724. Otherwise, if it is determined that the exit request was not made by the user, the manager continues the loop, at 722, with the timer still running.

Various implementations of the invention are realized in electronic hardware, computer software, or combinations of these technologies. Most implementations include one or more computer programs executed by a programmable computer. For example, in one implementation, methods for managing, diagnosing, and controlling the wireless data terminal device includes one or more computers executing software implementing the control and management processes. In general, each computer includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., mice and keyboards), and one or more output devices (e.g., display consoles and printers).

The computer programs include executable code that is usually stored in a persistent storage medium and then copied into memory at run-time. The processor executes the code by retrieving program instructions from memory in a prescribed order. When executing the program code, the computer receives data from the input and/or storage devices, performs operations on the data, and then delivers the resulting data to the output and/or storage devices.

Various illustrative implementations of the present invention have been described. However, one of ordinary skill in the art will see that additional implementations are also possible and within the scope of the present invention. For example, while the above description provides several general examples for managing, diagnosing, and controlling the wireless data terminal, other specific implementations are also contemplated.

In one specific implementation, the diagnostic module for the integrated wireless data terminal device is configured as a management and diagnostic unit for a data-only fixed wireless broadband modem designed as a plug-and-play solution, with an Ethernet and USB connection module embedded in the modem. The fixed wireless broadband modem concept enables many users in developing countries that have multi-user, networked environments to connect to the Internet.

Accordingly, the present invention is not limited to only those implementations described above.

What is claimed is:

1. A wireless data terminal apparatus, comprising:
a wireless data terminal unit configured to provide data communication over a wireless telecommunication network, said wireless data terminal unit including at least a data processor, an RF section, and a built-in diagnostic unit,
wherein said built-in diagnostic unit is configured to process and provide management information of said wireless data terminal unit to enable a browser-based user interface to manage said wireless data terminal unit; and
a local area network (LAN) access module coupled to said browser-based user interface and said wireless data terminal unit, said LAN access module including a browser protocol handler to manage user interface functions of said browser-based user interface.

2. The apparatus of claim 1, wherein said management information includes management, diagnostic, and control data.

3. The apparatus of claim 1, wherein said wireless data terminal unit includes a data channel for providing data interface to said LAN access module.

4. The apparatus of claim 3, wherein said LAN access module includes a USB driver for coupling said wireless data terminal unit to said LAN access module.

5. The apparatus of claim 1, wherein said wireless data terminal unit includes a diagnostic channel for providing access to said management information generated by said diagnostic unit.

6. The apparatus of claim 1, wherein said LAN access module includes a LAN access card to provide access to said browser-based user interface through a local area network.

7. The apparatus of claim 1, wherein said LAN access module is an Ethernet module.

8. The apparatus of claim 1, wherein said browser-based user interface is a web browser used to process and display web pages.

9. The apparatus of claim 1, wherein said browser-based user interface is a menu-driven graphical user interface.

10. The apparatus of claim 1, wherein said wireless data terminal unit is configured as a plug-in card for a personal computer to provide an interface to the Internet.

11. The apparatus of claim 1, wherein said wireless data terminal unit is configured as a plug-in device for a cellular phone providing wireless communication over a cellular network.

12. A system including a wireless data terminal apparatus, the system comprising:
a computing device detachably connected to said wireless data terminal apparatus, said computing device including a browser-based user interface;
said wireless data terminal apparatus including:
a wireless data terminal unit configured to provide data communication over a wireless telecommunication network, said wireless data terminal unit including at least a data processor, an RF section, and a built-in diagnostic unit,
wherein said built-in diagnostic unit is configured to process and provide management information of said wireless data terminal unit to enable said browser-based user interface to manage said wireless data terminal unit; and
a local area network (LAN) access module coupled to said browser-based user interface and said wireless data terminal unit, said LAN access module including a browser protocol handler to manage user interface functions of said browser-based user interface.

13. The system of claim 12, wherein said computing device includes a laptop computer.

14. A method comprising:
providing data communication over a wireless telecommunication network using a wireless data terminal unit;
processing and providing management information of said wireless data terminal unit using a built-in diagnostic unit in said wireless data terminal unit;
coupling a browser-based user interface to said wireless data terminal unit through a LAN access module to manage said wireless data terminal unit; and
managing user interface functions of said browser-based user interface using a browser protocol handler.

15. The method of claim 14, wherein said processing and providing management information of said wireless data terminal unit includes
accessing system status data of said wireless data terminal unit.

16. The method of claim 14, wherein said processing and providing management information of said wireless data terminal unit includes
configuring and modifying service parameters of said wireless data terminal unit.

17. The method of claim 14, wherein said processing and providing management information of said wireless data terminal unit includes
upgrading system software of said wireless data terminal unit.

18. A browser-based user interface accessible to a user suitable for managing a wireless data terminal unit, comprising:
means for accessing management configuration in a browser protocol handler;
means for accessing management information from a diagnostic module in said wireless data terminal unit; and
means for managing said wireless data terminal unit based on said management information configured by said browser protocol handler.

19. The browser-based user interface of claim 18, wherein said means for managing said wireless data terminal unit includes a menu-driven web page providing for controlling said wireless data terminal.

20. A computer program, stored in a tangible storage medium, for managing, diagnosing, and controlling a wireless data terminal unit, the program comprising executable instructions that cause a computer to:
provide data communication over a wireless telecommunication network using a wireless data terminal unit;
process and provide management information of said wireless data terminal unit using a built-in diagnostic unit in said wireless data terminal unit;
couple a browser-based user interface to said wireless data terminal unit through a LAN access module to manage said wireless data terminal unit; and
manage user interface functions of said browser-based user interface using a browser protocol handler.

21. The computer program of claim 20, wherein executable instructions that cause a computer to process and provide management information of said wireless data terminal unit includes executable instructions that cause a computer to
upgrade system software of said wireless data terminal unit.
